(19) United States
(12) Patent Application Publication
(10) Pub. No.: US 2024/0091683 A1
(43) Pub. Date: Mar. 21, 2024

(54) FILTER FLUSHING DEVICE AND FILTER FLUSHING METHOD

(71) Applicant: SEMES CO., LTD., Chungcheongnam-do (KR)

(72) Inventors: Byungwoo SIM, Chungcheongnam-do (KR); Bok Kyu LEE, Chungcheongnam-do (KR)

(21) Appl. No.: 18/354,823

(22) Filed: Jul. 19, 2023

(30) Foreign Application Priority Data
Sep. 19, 2022 (KR) 10-2022-0118193

(51) Int. Cl. B01D 29/66; B01D 46/00

(52) U.S. Cl. CPC B01D 29/66; B01D 46/0005; B01D 46/0027

(57) ABSTRACT

The present disclosure relates to a filter flushing device and a filter flushing method in which a filter can be flushed and which may include: a main body in which at least one filter can be mounted; a deionized (DI) water supply unit that can selectively supply a plurality of types of DI water having different temperatures to the filter mounted in the main body at desired time intervals, thereby flushing the filter; a drain unit that drains the DI water passing through the filter to the outside of the main body; and a control unit that is electrically connected to the DI water supply unit to apply a control signal to the DI water supply unit so that a temperature and a flow rate of the DI water supplied to the main body through the DI water supply unit can be controlled.

### CROSS-REFERENCE TO RELATED APPLICATION

This application claims priority on Korean Patent Application No. 10-2022-0118193, filed on Sep. 19, 2022, the content of which is incorporated herein by reference.

### BACKGROUND OF THE INVENTION

### Field of the Invention

The present disclosure relates to a filter flushing device and a filter flushing method, and more particularly, to a filter flushing device and a filter flushing method in which a filter can be flushed so that the filter used in a semiconductor process can be recycled and reused.

### Description of Related Art

In general, various types of treatment liquids are used in manufacturing processes of semiconductor devices, display panels, and the like. Concentrations, temperatures, and flow rates of these treatment liquids may be adjusted to suit process conditions by a treatment liquid supply device, and then supplied to a substrate processing device for processing a substrate, and during the supply process, filters may be used in the treatment liquid supply device to filter foreign substances included in the treatment liquids. In addition, filters may be used in an exhaust system to prevent by-products generated in manufacturing processes of semiconductor devices, display panels, and the like from being discharged to the outside air through the exhaust system.

These filters used to filter various foreign substances in manufacturing processes of semiconductor devices, display panels, and the like are quite expensive, and thus, in order to reduce costs, using a filter flushing device, processing such as flushing of A-class filters and regeneration of contaminated filters to make them reusable as B-class filters are performed, thereby reducing costs that may additionally occur due to filter replacements.

However, known filter flushing devices and filter flushing methods have problems that, in many cases, it is difficult to regenerate an issue filter using only cold deionized water (cold DIW) during flushing of the filter, a degree of flushing of the filter cannot be specifically identified since results before and after the flushing cannot be quantitatively known, only a wet filter can be used because only cold DIW is used, and thus, in the case of using a dry filter, a separate drying process is necessary after removing the filter.

### SUMMARY OF THE INVENTION

The present disclosure has been made to solve various problems including the above problems and an object of the present disclosure is to provide a filter flushing device and a filter flushing method in which a filter flushing effect can be increased by selectively supplying cold DIW and hot DIW at desired time intervals during a filter flushing process, a degree of flushing of the filter can be specifically identified by quantitatively comparing result values before and after the flushing of the filter through liquid particle check (LPC) and resistivity check, and both wet filters and dry filters can be used by drying filters after flushing using a filter drying function. However, these problems are exemplary, and the scope of the present disclosure is not limited thereto.

According to one embodiment of the present disclosure, a filter flushing device is provided. The filter flushing device may include: a main body in which at least one filter can be mounted; a deionized water (DI water) supply unit that can selectively supply a plurality of types of DI water having different temperatures to the filter mounted in the main body at desired time intervals, thereby flushing the filter; a drain unit that drains the DI water passing through the filter to the outside of the main body; and a control unit that is electrically connected to the DI water supply unit to apply a control signal to the DI water supply unit so that a temperature and a flow rate of the DI water supplied to the main body through the DI water supply unit can be controlled.

According to one embodiment of the present disclosure, the main body may include: a first filter mounting unit in which a first filter is mounted; a second filter mounting unit in which a second filter is mounted; a first supply line that is connected to the first filter mounting unit to guide supply of the DI water to the first filter mounting unit; a second supply line that is connected to the second filter mounting unit to guide supply of the DI water to the second filter mounting unit; a distribution line that provides connection between the first supply line and the second supply line so that at least a part of the DI water supplied to the first supply line or the second supply line through the DI water supply unit can be distributed to the second supply line or the first supply line; a first drain line that drains the DI water passing through the first filter mounting unit to the drain unit; and a second drain line that drains the DI water passing through the second filter mounting unit to the drain unit.

According to one embodiment of the present disclosure, the DI water supply unit may be connected to the first supply line or the second supply line to supply the DI water to the first filter mounting unit and the second filter mounting unit and selectively supply a first DI water having a first temperature and a second DI water having a second temperature lower than the first temperature at desired time intervals.

According to one embodiment of the present disclosure, a sensing unit that is connected to the first drain line and the second drain line to sense at least one of liquid particle check (LPC) and resistivity of the first DI water or the second DI water passing through the first filter mounting unit and the second filter mounting unit may be further included.

According to one embodiment of the present disclosure, the control unit may include a DI water supply control unit that applies, in the case of flushing the first filter and the second filter, a flushing signal to the DI water supply unit to supply the first DI water having the first temperature to the first filter mounting unit and the second filter mounting unit for a first time so that the first filter and the second filter can be primarily flushed, and then supply the second DI water having the second temperature to the first filter mounting unit and the second filter mounting unit for a second time so that the first filter and the second filter can be secondarily flushed.

According to one embodiment of the present disclosure, the control unit may further include a sensing control unit that receives a sensing signal from the sensing unit so that at least one of an LPC value and a resistivity value of the first DI water or the second DI water passing through the first filter mounted in the first filter mounting unit and the second filter mounted in the second filter mounting unit can be measured.

According to one embodiment of the present disclosure, the sensing control unit may include a flushing sensing unit that applies a control signal to the DI water supply unit so that the second DI water having the second temperature can be supplied after the flushing of the first filter and the second filter under the control of the DI water supply control unit and that receives a flushing sensing signal from the sensing unit so that a flushing LPC value and a flushing resistivity value of the second DI water passing through the flushed first and second filters can be measured.

According to one embodiment of the present disclosure, the sensing control unit may further include an initial sensing unit that applies a control signal to the DI water supply unit so that the second DI water having the second temperature can be supplied before the flushing of the first filter and the second filter under the control of the DI water supply control unit and that receives an initial sensing signal from the sensing unit so that an initial LPC value and an initial resistivity value of the second DI water passing through the first filter and the second filter before the flushing can be measured, and a comparison and determination unit that compares the initial LPC value and the initial resistivity value measured by the initial sensing unit with the flushing LPC value and the flushing resistivity value measured by the flushing sensing unit.

According to one embodiment of the present disclosure, the comparison and determination unit may determine that additional flushing of the first filter and the second filter is required in a case in which differences between the initial LPC value and the initial resistivity value, and the flushing LPC value and the flushing resistivity value are less than or equal to predetermined differences set in advance, and may apply a re-flushing signal to the DI water supply control unit so that the first filter and the second filter can be re-flushed under the control of the DI water supply control unit.

According to one embodiment of the present disclosure, a dry gas supply unit that is connected to the second supply line or the first supply line to supply a dry gas to the first filter mounting unit and the second filter mounting unit so that the first filter and the second filter which have been flushed by the first DI water and the second DI water can be dried may be further included.

According to one embodiment of the present disclosure, the control unit may further include a drying control unit that applies a drying signal to the dry gas supply unit to supply supplying the dry gas to the first filter mounting unit and the second filter mounting unit after the flushing of the first filter and the second filter under the control of the DI water supply control unit so that the first filter and the second filter can be dried.

According to one embodiment of the present disclosure, the dry gas supply unit may supply nitrogen (N₂) gas as the dry gas.

According to another embodiment of the present disclosure, a filter flushing method is provided. The filter flushing method may include: a filter mounting step of mounting at least one filter in a main body of a filter flushing device; a flushing step of selectively supplying a plurality of types of deionized water (DI water) having different temperatures to the filter mounted in the main body at desired time intervals, thereby flushing the filter; and a filter removing step of removing the filter from the main body of the filter flushing device.

According to another embodiment of the present disclosure, the flushing step may include a first flushing step of supplying a first DI water having a first temperature to a first filter mounting unit in which a first filter is mounted and a second filter mounting unit in which a second filter is mounted for a first time to perform primary flushing of the first filter and the second filter, and a second flushing step of supplying a second DI water having a second temperature lower than the first temperature to the first filter mounting unit in which the first filter is mounted and the second filter mounting unit in which the second filter is mounted for a second time to perform secondary flushing of the first filter and the second filter.

According to another embodiment of the present disclosure, the flushing step may include a flushing sensing step of measuring a flushing LPC value and a flushing resistivity value of the second DI water passing through the flushed first and second filters in the second flushing step.

According to another embodiment of the present disclosure, an initial sensing step of supplying the second DI water having the second temperature before the flushing step and measuring an initial LPC value and an initial resistivity value of the second DI water passing through the first filter and the second filter before the flushing may be further included.

According to another embodiment of the present disclosure, a comparison and determination step of comparing the initial LPC value and the initial resistivity value measured in the initial sensing step with the flushing LPC value and the flushing resistivity value measured in the flushing sensing step may be further included.

According to another embodiment of the present disclosure, in the comparison and determination step, in a case in which differences between the initial LPC value and the initial resistivity value, and the flushing LPC value and the flushing resistivity value are less than or equal to predetermined differences, additional flushing of the first filter and the second filter may be determined to be required, and the flushing step may be re-executed so that the first filter and the second filter can be re-flushed.

According to another embodiment of the present disclosure, a drying step of drying the first filter and the second filter by supplying a dry gas to the first filter mounting unit and the second filter mounting unit after the flushing of the first filter and the second filter in the flushing step may be further included.

According to another embodiment of the present disclosure, a filter flushing device is provided. The filter flushing device may include: a main body in which at least one filter can be mounted; a deionized water (DI water) supply unit that can selectively supply a plurality of types of DI water having different temperatures to the filter mounted in the main body at desired time intervals, thereby flushing the filter; a drain unit that drains the DI water passing through the filter to the outside of the main body; and a control unit that is electrically connected to the DI water supply unit to apply a control signal to the DI water supply unit so that a temperature and a flow rate of the DI water supplied to the main body through the DI water supply unit can be controlled, wherein the main body includes: a first filter mounting unit in which a first filter is mounted; a second filter mounting unit in which a second filter is mounted; a first supply line that is connected to the first filter mounting unit to guide supply of the DI water to the first filter mounting unit; a second supply line that is connected to the second filter mounting unit to guide supply of the DI water to the second filter mounting unit; a distribution line that provides connection between the first supply line and the second supply line so that at least a part of the DI water supplied to the first supply line or the second supply line through the DI water supply unit to the second supply line or the first supply line; a first drain line that drains the DI water passing through the first filter mounting unit to the drain unit; and a second drain line that drains the DI water passing through the second filter mounting unit to the drain unit, the main body may further include: a dry gas supply unit that is connected to the second supply line or the first supply line to supply a dry gas to the first filter mounting unit and the second filter mounting unit so that the first filter and the second filter which have been flushed by a first DI water and a second DI water can be dried; and a sensing unit that is connected to the first drain line and the second drain line to sense at least one of liquid particle check (LPC) and resistivity of the first DI water or the second DI water passing through the first filter mounting unit and the second filter mounting unit, and the DI water supply unit is connected to the first supply line or the second supply line to supply the DI water to the first filter mounting unit and the second filter mounting unit and can selectively supply the first DI water having a first temperature and the second DI water having a second temperature lower than the first temperature at desired time intervals.

According to one embodiment of the present disclosure configured as described above, by selectively supplying cold deionized water (cold DIW) and hot deionized water (hot DIW) through the DI water supply unit to the filter mounting unit in which the filter is mounted at desired time intervals, it is possible to further increase the filter flushing effect using both cleaning characteristics of the cold DIW and cleaning characteristics of the hot DIW.

In addition, by quantitatively comparing result values before and after the flushing of the filter through liquid particle check (LPC) and resistivity check of the DI water drained after the flushing of the filter, it is possible to specifically identify a degree of flushing of the filter and further increase flushing efficiency of the filter.

Further, by supplying the dry gas to the filter mounting unit in which the filter is mounted through the dry gas supply unit after the flushing of the filter with the DI water to dry the filter after the flushing using the filter drying function, it is possible to realize the filter flushing device and the filter flushing method in which both wet and dry filters can be used. Of course, the scope of the present disclosure is not limited by these effects.

### BRIEF DESCRIPTION OF THE DRAWINGS

FIG. 1 is a conceptual diagram schematically showing a configuration of a filter flushing device according to one embodiment of the present disclosure.

FIGS. 2 and 3 are block diagrams showing various embodiments of a control unit of the filter flushing device of FIG. 1.

FIG. 4 is a flowchart showing a filter flushing method in order according to another embodiment of the present disclosure.

FIGS. 5 to 8 are conceptual diagrams schematically showing each step of the filter flushing method of FIG. 4.

FIG. 9 is a flowchart showing a filter flushing method in order according to yet another embodiment of the present disclosure.

### DETAILED DESCRIPTION OF THE INVENTION

Hereinafter, various preferred embodiments of the present disclosure will be described in detail with reference to the accompanying drawings.

It should be understood that embodiments of the present disclosure are provided to explain the present disclosure more completely to those having ordinary knowledge in the art, and the following embodiments may be modified in various different forms and the scope of the present disclosure is not limited to the following embodiments. Rather, these embodiments are provided to make the present disclosure more sufficient and complete and to completely convey the idea of the present disclosure to those skilled in the art. In addition, in the drawings, thicknesses or sizes of each layer are exaggerated for convenience and clarity of description.

Embodiments of the present disclosure will be described below with reference to the drawings schematically showing ideal embodiments of the present disclosure. In the drawings, for example, depending on manufacturing techniques and/or tolerances, variations of the illustrated shapes can be anticipated. Accordingly, embodiments of the idea of the present disclosure should not be construed as being limited to a specific shape of a region illustrated in the present specification and should include, for example, changes in shape caused by manufacturing.

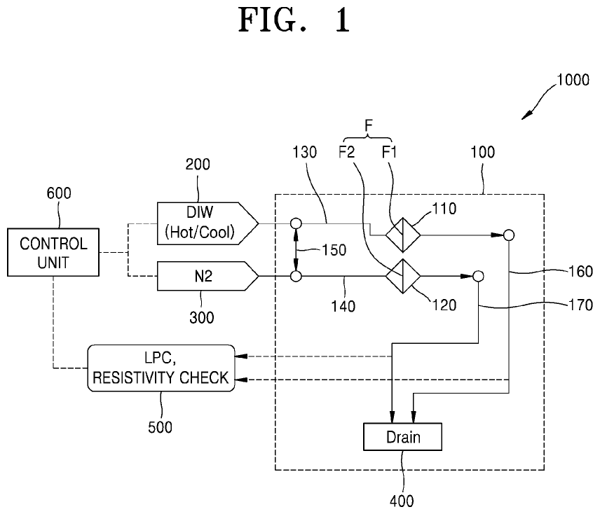

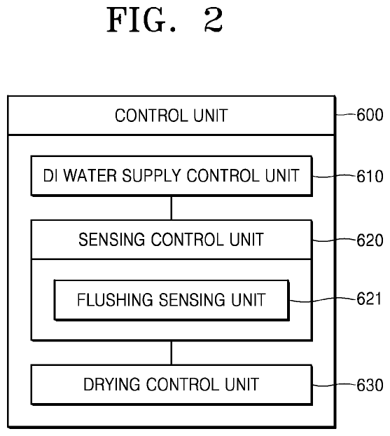

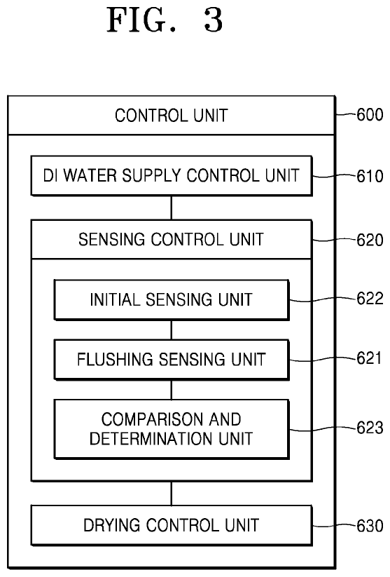

FIG. 1 is a conceptual diagram schematically showing a configuration of a filter flushing device 1000 according to one embodiment of the present disclosure, and FIGS. 2 and 3 are block diagrams showing various embodiments of a control unit 600 of the filter flushing device 1000 of FIG. 1.

First, as shown in FIG. 1, the filter flushing device 1000 according to one embodiment of the present disclosure may largely include a main body 100, a deionized water supply unit 200, a dry gas supply unit 300, a drain unit 400, a sensing unit 500, and a control unit 600 for controlling them.

As shown in FIG. 1, at least one filter F may be mounted in the main body 100. For example, the main body 100 may be configured to include a first filter mounting unit 110 in which a first filter F1 is mounted, a second filter mounting unit 120 in which a second filter F2 is mounted, a first supply line 130 that is connected to the first filter mounting unit 110 to guide supply of deionized water to the first filter mounting unit 110, a second supply line 140 that is connected to the second filter mounting unit 120 to guide supply of the deionized water to the second filter mounting unit 120, a distribution line 150 that provides connection between the first supply line 130 and the second supply line 140 so that at least a part of the deionized water supplied to the first supply line 130 or the second supply line 140 through the deionized water supply unit 200, which will be described later, can be distributed to the second supply line 140 or the first supply line 130, a first drain line 160 that drains the deionized water passing through the first filter mounting unit 110 to the drain unit 400, and a second drain line 170 that drains the deionized water passing through the second filter mounting unit 120 to the drain unit 400.

Although the configuration in which the two filter mounting units 110 and 120 are included in the main body 100 and the two filters F1 and F2 are mounted therein has been described as an example in the present embodiment, the present disclosure is not limited to the configuration of FIG. 1, and filter mounting units may be provided in a wide variety of numbers as needed. In this case, according to the number of filter mounting units, the number of supply lines and drain lines may be provided in a wide variety of numbers so that supply and drain of the deionized water to and from each filter mounting unit can be separately performed.

As shown in FIG. 1, the deionized water supply unit 200 can selectively supply a plurality of deionized water (DI water) having different temperatures to the filter F mounted in the main body 100 at desired time intervals, thereby flushing the filter F.

For example, the DI water supply unit 200 is connected to the first supply line 130 to supply the DI water to the first filter mounting unit 110 and the second filter mounting unit 120 and can selectively supply a first DI water HDIW having a first temperature and a second DI water CDIW having a second temperature lower than the first temperature at desired time intervals under control of the control unit 600.

In this case, the first DI water HDIW and the second DI water CDIW supplied from the DI water supply unit 200 to the first supply line 130 side may also be distributed and supplied to the second supply line 140 through the distribution line 150.

In this way, hot DI water (hot DIW) having a relatively high temperature is supplied to the filters F1 and F2 mounted in the filter mounting units 110 and 120 through the DI water supply unit 200, so that a filter flushing effect can be further increased. For example, a binding force with contaminants in a filter or ionized water residues in a membrane becomes higher at a high temperature, and thus in the case of flushing the filter with the hot DIW, the flushing effect can be further increased.

In addition, after the hot DIW, cold DI water (cold DIW) having a relatively low temperature is supplied to the filters F1 and F2 mounted in the filter mounting units 110 and 120, so that and temperatures of the filters F1 and F2 can be lowered. For example, in a flushing process using the hot DIW, bonding of the membrane may be slightly increased, but it can be recovered by lowering the temperatures with the cold DIW.

The dry gas supply unit 300 may be connected to the second supply line 140 to supply a dry gas to the first filter mounting unit 110 and the second filter mounting unit 120 so that the first filter (F1) and the second filter (F2) which have been flushed by the first DI water HDIW and the second DI water CDIW can be dried.

In this case, the dry gas supply unit 300 may supply nitrogen (N₂) as the dry gas. However, the dry gas is not limited to nitrogen, and all types of inert gases that have a low reaction rate with other elements and can efficiently dry the filter F may be used. In addition, the dry gas supplied from the dry gas supply unit 300 to the second supply line 140 may be distributed and supplied to the first supply line 130 side through the distribution line 150.

Although the configuration in which the DI water supply unit 200 is connected to the first supply line 130 side and the dry gas supply unit 300 is connected to the second supply line 140 side has been described as an example in the present embodiment, the present disclosure is not limited to the configuration of FIG. 1, and since the first supply line 130 and the second supply line 140 communicate with each other through the distribution line 150, the DI water supply unit 200 may be connected to the second supply line 140 side, and the dry gas supply unit 300 may be connected to the first supply line 130 side.

Also, the drain unit 400 may be connected to the first drain line 160 and the second drain line 170 and drain the DI water passing through the first filter F1 mounted in the first filter mounting unit 110 and the second filter F2 mounted in the second filter mounting unit 120 to the outside of the main body 100.

In this case, the sensing unit 500 connected to middle portions of the first drain line 160 and the second drain line 170 can sense at least one of liquid particle check (LPC) and resistivity of the first DI water HDIW and the second DI water CDIW drained through the first filter mounting unit 110 and the second filter mounting unit 120.

Further, the control unit 600 may be electrically connected to the DI water supply unit 200, the dry gas supply unit 300, and the sensing unit 500 to apply a control signal to the DI water supply unit 200 so that a temperature and a flow rate of the DI water supplied to the main body 100 through the DI water supply unit 200 can be controlled, to apply a control signal to the dry gas supply unit 300 so that a temperature and a flow rate of the dry gas supplied to the main body 100 through the dry gas supply unit 300 can be controlled, or to receive sensed values of the LPC and the resistivity of the DI water from the sensing unit 500.

More specifically describing such a configuration of the control unit 600, for example, like the control unit 600 according to one embodiment of the present disclosure shown in FIG. 2, the control unit 600 may include a DI water supply control unit 610 that applies, in the case of flushing the first filter (F1) and the second filter (F2), a flushing signal to the DI water supply unit 200 to supply the first DI water HDIW having the first temperature to the first filter mounting unit 110 and the second filter mounting unit 120 for a first time so that the first filter F1 and the second filter F2 can be primarily flushed at a high temperature, and then to supply the second DI water CDIW having the second temperature to the first filter mounting unit 110 and the second filter mounting unit 120 for a second time so that the first filter F1 and the second filter F2 can be secondarily flushed at a low temperature.

In addition, the control unit 600 may include a sensing control unit 620 that receives a sensing signal from the sensing unit 500 so that at least one of a LPC value and a resistivity value of the first DI water HDIW or the second DI water CDIW passing through the first filter F1 mounted in the first filter mounting unit 110 and the second filter F2 mounted in the second filter mounting unit 120 can be measured.

In this case, the sensing control unit 620 may be configured to include a flushing sensing unit 621 that applies a control signal to the DI water supply unit 200 so that the second DI water CDIW having the second temperature can be supplied after the flushing of the first filter F1 and the second filter F2 under the control of the DI water supply control unit 610 and receives a flushing sensing signal from the sensing unit 500 so that a flushing LPC value and a flushing resistivity value of the second DI water (CDIW) passing through the flushed first and second filters F1 and F2 can be measured.

Accordingly, a degree of flushing of the filter F can be quantitatively confirmed through the LPC and resistivity checks of the first filter F1 and the second filter F2 which have been flushed.

Also, the control unit 600 may be configured to include a drying control unit 630 that applies a drying signal to the dry gas supply unit 300 so that the dry gas can be supplied to the first filter mounting unit 110 and the second filter mounting unit 120 to dry the first filter F1 and the second filter F2 after the flushing of the first filter F1 and the second filter F2 under the control of the DI water supply control unit 610.

Accordingly, by drying the filter F after the flushing using a drying function of the dry gas, both wet and dry filters can be used in the filter flushing device 1000.

In addition, as shown in FIG. 3, according to the control unit 600 according to another embodiment of the present disclosure, the sensing control unit 620 of the control unit 600 may be configured to further include an initial sensing unit 622 that applies a control signal to the DI water supply unit 200 so that the second DI water CDIW having the second temperature can be supplied before the flushing of the first filter F1 and the second filter F2 under the control of the DI water supply control unit 610 and that receives an initial sensing signal from the sensing unit 500 so that the initial LPC value and the initial resistivity value of the second DI water CDIW passing through the first filter F1 and the second filter F2 before the flushing can be measured, and a comparison and determination unit 623 that compares the initial LPC value and the initial resistivity value measured by the initial sensing unit 622 with the flushing LPC value and the flushing resistivity value measured by the flushing sensing unit 621.

According to such a configuration, the comparison and determination unit 623 of the sensing control unit 620 can determine that additional flushing of the first filter F1 and the second filter F2 is required in a case in which differences between the initial LPC value and the initial resistivity value, and the flushing LPC value and the flushing resistivity value are less than or equal to predetermined differences, and can apply a re-flushing signal to the DI water supply control unit 610 so that the first filter F1 and the second filter F2 can be re-flushed under the control of the DI water supply control unit 610.

In this way, by comparing the LPC values and the resistivity values before and after the flushing of the filter F through the comparison and determination unit 623, cleaning power of the filter F in the flushing process can be quantitatively confirmed to manage cleanliness, and in a case in which the cleaning power of the filter F through the flushing process falls short of a standard value, cleanliness of the filter F can be managed more efficiently through an additional flushing process.

Accordingly, according to the filter flushing device 1000 according to various embodiments of the present disclosure, by selectively supplying cold DIW and hot DIW through the DI water supply unit 200 to the filter mounting units 110 and 120 equipped with the filter F at desired time intervals, the flushing effect on the filter F can be further increased by using both cleaning characteristics of cold DIW and hot DIW.

In addition, by quantitatively comparing the result values before and after the flushing of the filter F through the liquid particle check (LPC) and the resistivity check of the DI water drained after the flushing of the filter F, the degree of flushing of the filter F can be specifically identified and flushing efficiency of the filter F can be further increased.

Further, by supplying the dry gas to the filter mounting units 110 and 120 equipped with the filter F through the dry gas supply unit 300 after the flushing of the filter F with the DI water and drying the filter F after the flushing using the drying function for the filter F, both wet and dry filters can be used for the flushing process.

A filter flushing method using the above-described filter flushing device 1000 will be described below.

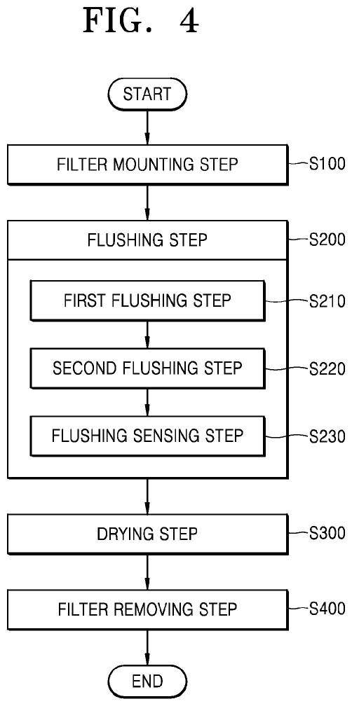

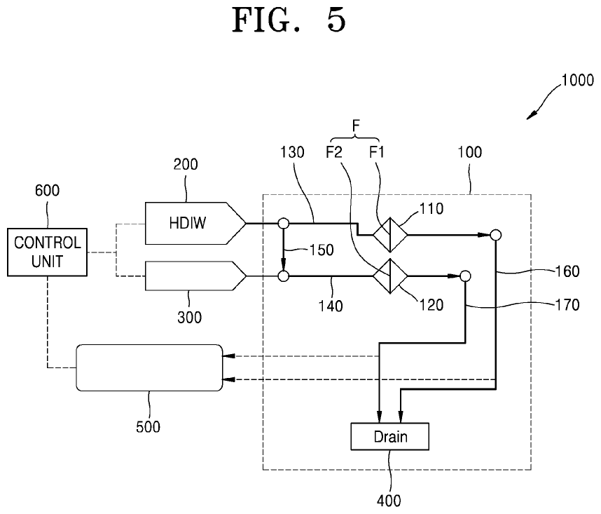

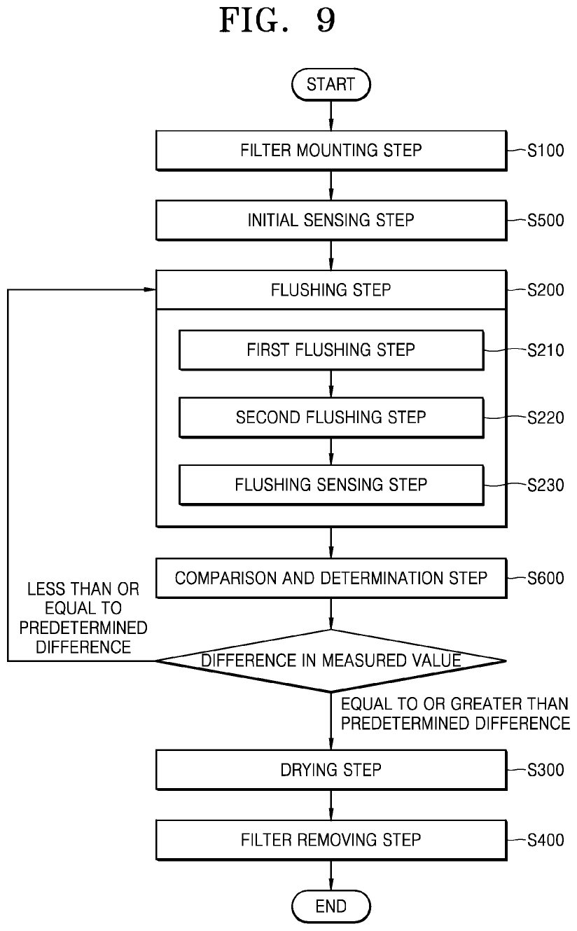

FIG. 4 is a flowchart showing a filter flushing method in order according to another embodiment of the present disclosure, FIGS. 5 to 8 are conceptual diagrams schematically showing each step of the filter flushing method of FIG. 4, and FIG. 9 is a flowchart showing a filter flushing method in order according to yet another embodiment of the present disclosure.

Referring to FIG. 4, the filter flushing method according to another embodiment of the present disclosure may largely proceed in the order of a filter mounting step S100, a flushing step S200, a drying step S300, and a filter removing step S400.

First, in the filter mounting step S100, at least one filter F may be mounted in the filter mounting units 110 and 120 of the main body 100 of the filter flushing device 1000.

Subsequently, in the flushing step S200, a plurality of types of deionized water (DI water) having different temperatures may be selectively supplied to the filter F mounted in the main body 100 at desired time intervals, thereby flushing the filter F.

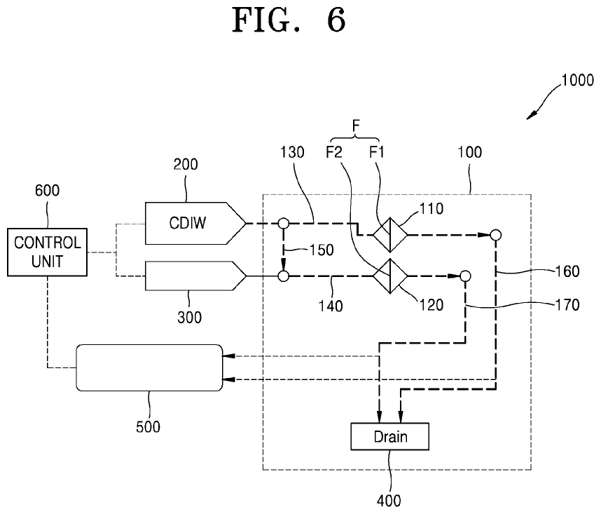

For example, in the flushing step S200, as shown in FIGS. 4 and 5, a first flushing step S210 of supplying the first DI water HDIW having the first temperature to the first filter mounting unit 110 in which the first filter F1 is mounted and the second filter mounting unit 120 in which the second filter F2 is mounted for the first time to perform primary flushing of the first filter F1 and the second filter F2 may be performed, and then, as shown in FIGS. 4 and 6, a second flushing step S220 of supplying the second DI water CDIW having the second temperature lower than the first temperature to the first filter mounting unit 110 in which the first filter F1 is mounted and the second filter mounting unit 120 in which the second filter F2 is mounted for the second time to perform secondary flushing of the first filter F1 and the second filter F2 may be performed.

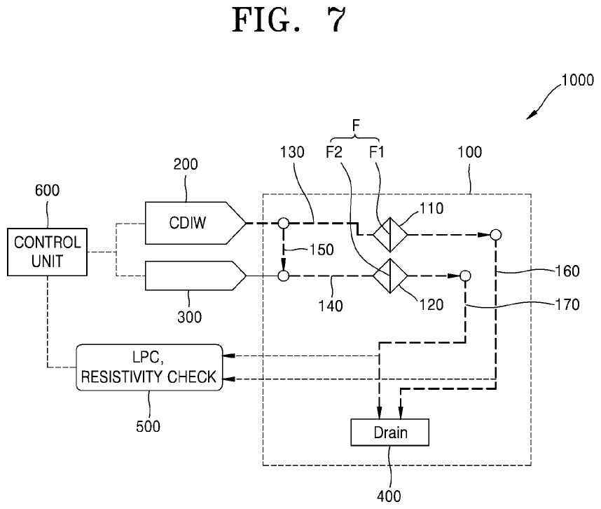

Subsequently, as shown in FIGS. 4 and 7, in the flushing step S200, by measuring the flushing LPC value and the flushing resistivity value of the second DI water CDIW passing through the flushed first and second filters F1 and F2 in the second flushing step S220, degrees of flushing of the first filter F1 and the second filter F2 may be determined and managed.

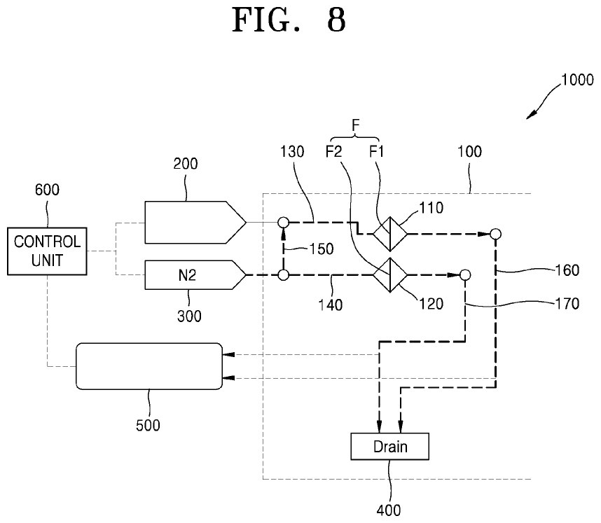

After such a flushing step S200 has been performed, as shown in FIGS. 4 and 8, through the drying step S300, the first filter F1 and the second filter F2 may be flushed in the flushing step S200, and then, nitrogen N 2) serving as the dry gas may be supplied to the first filter mounting unit 110 and the second filter mounting unit 120 to dry the first filter F1 and the second filter F2.

Such a drying step S300 may be performed in a case in which the filter F flushed in the filter flushing device 1000 is a dry filter, and in the case of a wet filter, the drying step S300 may be omitted.

Subsequently, as shown in FIG. 4, the filter F may be removed from the main body 100 of the filter flushing device 1000 through the filter removing step S400.

In addition, as shown in FIG. 9, according to the filter flushing method according to yet another embodiment of the present disclosure, an initial sensing step S500 of supplying the second DI water CDIW having the second temperature before the flushing step S200 and measuring the initial LPC value and the initial resistivity value of the second DI water CDIW passing through the first filter F1 and the second filter F2 before the flushing may be performed, and a comparison and determination step S600 of comparing the initial LPC value and the initial resistivity value measured in the initial sensing step S500 with the flushing LPC value and the flushing resistivity value measured in the flushing sensing step S230 after the flushing step S200 may be performed.

Accordingly, in the comparison and determination step S600, in a case in which differences between the initial LPC value and the initial resistivity value, and the flushing LPC value and the flushing resistivity value are less than or equal to predetermined differences, additional flushing of the first filter F1 and the second filter (F2) may be determined to be required and the flushing step S200 may be re-executed so that the first filter F1 and the second filter F2 can be re-flushed, and in a case in which the differences between the initial LPC value and the initial resistivity value, and the flushing LPC value and the flushing resistivity value are equal to or greater than the predetermined differences, the filter removing step S400 may be performed and the first filter F1 and the second filter F2 which have been flushed may be removed.

In this way, by comparing the LPC values and the resistivity values before and after the flushing of the filter F through the comparison and determination step S600, the cleaning power of the filter F in the flushing process can be quantitatively confirmed to manage cleanliness, and in a case in which the cleaning power of the filter F through the flushing process falls short of a standard value, cleanliness of the filter F can be managed more efficiently through an additional flushing process.

Accordingly, according to the filter flushing methods according to various embodiments of the present disclosure, by selectively supplying the cold DIW and the hot DIW to the filter mounting units 110 and 120 equipped with the filter F at desired time intervals through the flushing step S200, the flushing effect on the filter F may be further increased by using both the cleaning characteristics of the cold DIW and the hot DIW.

In addition, by quantitatively comparing the result values before and after the flushing of the filter F through the liquid particle check (LPC) and the resistivity check of the DI water drained after the flushing of the filter F, the degree of flushing of the filter F can be specifically identified and the flushing efficiency of the filter F can be further increased.

Further, by supplying the dry gas to the filter mounting units 110 and 120 equipped with the filter F through the drying step S300 after the flushing of the filter F with the DI water to dry the filter F after the flushing using the drying function for the filter F, both wet and dry filters can be used in the flushing process.

It should be understood that the present disclosure has been described with reference to the embodiments illustrated in the drawings, but these are merely illustrative and various modifications and other equivalent embodiments can be made by those having ordinary knowledge in the art from the embodiments. Therefore, the true technical scope of the present disclosure should be determined by the technical idea of the appended claims.

### EXPLANATION OF REFERENCES

100 Main body
110 First filter mounting unit
120 Second filter mounting unit
130 First supply line
140 Second supply line
150 Distribution line
160 First drain line
170 Second drain line
200 Deionized (DI) water supply unit
300 Dry gas supply unit
400 Drain unit
500 Sensing unit
600 Control unit
610 Deionized (DI) water supply control unit
620 Sensing control unit
621 Flushing sensing unit
622 Initial sensing unit
623 Comparison and determination unit
630 Drying control unit
1000 Filter flushing device
F Filter
F1First filter
F2 Second filter

What is claimed is:

1. A filter flushing device comprising:
a main body in which at least one filter can be mounted;
a deionized (DI) water supply unit that can selectively supply a plurality of types of DI water having different temperatures to the filter mounted in the main body at desired time intervals, thereby flushing the filter;
a drain unit that drains the DI water passing through the filter to the outside of the main body; and
a control unit that is electrically connected to the DI water supply unit to apply a control signal to the DI water supply unit so that a temperature and a flow rate of the DI water supplied to the main body through the DI water supply unit can be controlled.

2. The filter flushing device according to claim 1,
wherein the main body includes:
a first filter mounting unit in which a first filter is mounted;
a second filter mounting unit in which a second filter is mounted;
a first supply line that is connected to the first filter mounting unit to guide supply of the DI water to the first filter mounting unit;
a second supply line that is connected to the second filter mounting unit to guide supply of the DI water to the second filter mounting unit;
a distribution line that provides connection between the first supply line and the second supply line so that at least a part of the DI water supplied to the first supply line or the second supply line through the DI water supply unit can be distributed to the second supply line or the first supply line;
a first drain line that drains the DI water passing through the first filter mounting unit to the drain unit; and
a second drain line that drains the DI water passing through the second filter mounting unit to the drain unit.

3. The filter flushing device according to claim 2, wherein the DI water supply unit is connected to the first supply line or the second supply line to supply the DI water to the first filter mounting unit and the second filter mounting unit and selectively supplies a first DI water having a first temperature and a second DI water having a second temperature lower than the first temperature at desired time intervals.

4. The filter flushing device according to claim 3, further comprising a sensing unit that is connected to the first drain line and the second drain line to sense at least one of liquid particle check (LPC) and resistivity of the first DI water or the second DI water passing through the first filter mounting unit and the second filter mounting unit.

5. The filter flushing device according to claim 4, wherein the control unit includes a DI water supply control unit that applies, in the case of flushing the first filter and the second filter, a flushing signal to the DI water supply unit to supply the first DI water having the first temperature to the first filter mounting unit and the second filter mounting unit for a first time so that the first filter and the second filter can be primarily flushed, and then supply the second DI water having the second temperature to the first filter mounting unit and the second filter mounting unit for a second time so that the first filter and the second filter can be secondarily flushed.

6. The filter flushing device according to claim 5, wherein the control unit further includes a sensing control unit that receives a sensing signal from the sensing unit so that at least one of an LPC value and a resistivity value of the first DI water or the second DI water passing through the first filter mounted in the first filter mounting unit and the second filter mounted in the second filter mounting unit can be measured.

7. The filter flushing device according to claim 6, wherein the sensing control unit includes a flushing sensing unit that applies a control signal to the DI water supply unit so that the second DI water having the second temperature can be supplied after the flushing of the first filter and the second filter under the control of the DI water supply control unit and that receives a flushing sensing signal from the sensing unit so that a flushing LPC value and a flushing resistivity value of the second DI water passing through the flushed first and second filters can be measured.

8. The filter flushing device according to claim 7,
wherein the sensing control unit further includes an initial sensing unit that applies a control signal to the DI water supply unit so that the second DI water having the second temperature can be supplied before the flushing of the first filter and the second filter under the control of the DI water supply control unit and that receives an initial sensing signal from the sensing unit so that an initial LPC value and an initial resistivity value of the second DI water passing through the first filter and the second filter before the flushing can be measured, and
a comparison and determination unit that compares the initial LPC value and the initial resistivity value measured by the initial sensing unit with the flushing LPC value and the flushing resistivity value measured by the flushing sensing unit.

9. The filter flushing device according to claim 8, wherein the comparison and determination unit determines that additional flushing of the first filter and the second filter is required in a case in which differences between the initial LPC value and the initial resistivity value, and the flushing LPC value and the flushing resistivity value are less than or equal to predetermined differences set in advance, and applies a re-flushing signal to the DI water supply control unit so that the first filter and the second filter can be re-flushed under the control of the DI water supply control unit.

10. The filter flushing device according to claim 5, further comprising a dry gas supply unit that is connected to the second supply line or the first supply line to supply a dry gas to the first filter mounting unit and the second filter mounting unit so that the first filter and the second filter which have been flushed by the first DI water and the second DI water can be dried.

11. The filter flushing device according to claim 10, wherein the control unit further includes a drying control unit that applies a drying signal to the dry gas supply unit to supply the dry gas to the first filter mounting unit and the second filter mounting unit after the flushing of the first filter and the second filter under the control of the DI water supply control unit so that the first filter and the second filter can be dried.

12. The filter flushing device according to claim 10, wherein the dry gas supply unit supplies nitrogen (N₂) gas as the dry gas.

13. A filter flushing method comprising:
a filter mounting step of mounting at least one filter in a main body of a filter flushing device;
a flushing step of selectively supplying a plurality of types of deionized (DI) water having different temperatures to the filter mounted in the main body at desired time intervals, thereby flushing the filter; and
a filter removing step of removing the filter from the main body of the filter flushing device.

14. The filter flushing method according to claim 13,
wherein the flushing step includes a first flushing step of supplying a first DI water having a first temperature to a first filter mounting unit in which a first filter is mounted and a second filter mounting unit in which a second filter is mounted for a first time to perform primary flushing of the first filter and the second filter, and
a second flushing step of supplying a second DI water having a second temperature lower than the first temperature to the first filter mounting unit in which the first filter is mounted and the second filter mounting unit in which the second filter is mounted for a second time to perform secondary flushing of the first filter and the second filter.

15. The filter flushing method according to claim 14, wherein the flushing step includes a flushing sensing step of measuring a flushing LPC value and a flushing resistivity value of the second DI water passing through the flushed first and second filters in the second flushing step.

16. The filter flushing method according to claim 15, further comprising an initial sensing step of supplying the second DI water having the second temperature before the flushing step and measuring an initial LPC value and an initial resistivity value of the second DI water passing through the first filter and the second filter before the flushing.

17. The filter flushing method according to claim 16, further comprising a comparison and determination step of comparing the initial LPC value and the initial resistivity value measured in the initial sensing step with the flushing LPC value and the flushing resistivity value measured in the flushing sensing step.

18. The filter flushing method according to claim 17, wherein, in the comparison and determination step, in a case in which differences between the initial LPC value and the initial resistivity value, and the flushing LPC value and the flushing resistivity value are less than or equal to predetermined differences, additional flushing of the first filter and the second filter is determined to be required, and the flushing step is re-executed so that the first filter and the second filter can be re-flushed.

19. The filter flushing method according to claim 14, further comprising a drying step of supplying a dry gas to the first filter mounting unit and the second filter mounting unit after the flushing of the first filter and the second filter in the flushing step to dry the first filter and the second filter.

20. A filter flushing device comprising:
a main body in which at least one filter can be mounted;
a deionized (DI) water supply unit that can selectively supply a plurality of types of DI water having different temperatures to the filter mounted in the main body at desired time intervals, thereby flushing the filter;
a drain unit that drains the DI water passing through the filter to the outside of the main body; and
a control unit that is electrically connected to the DI water supply unit to apply a control signal to the DI water supply unit so that a temperature and a flow rate of the DI water supplied to the main body through the DI water supply unit can be controlled,
wherein the main body includes:
a first filter mounting unit in which a first filter is mounted;
a second filter mounting unit in which a second filter is mounted;
a first supply line that is connected to the first filter mounting unit to guide supply of the DI water to the first filter mounting unit;
a second supply line that is connected to the second filter mounting unit to guide supply of the DI water to the second filter mounting unit;
a distribution line that provides connection between the first supply line and the second supply line so that at least a part of the DI water supplied to the first supply line or the second supply line through the DI water supply unit to the second supply line or the first supply line;
a first drain line that drains the DI water passing through the first filter mounting unit to the drain unit; and
a second drain line that drains the DI water passing through the second filter mounting unit to the drain unit,
the main body further includes:
a dry gas supply unit that is connected to the second supply line or the first supply line to supply a dry gas to the first filter mounting unit and the second filter mounting unit so that the first filter and the second filter which have been flushed by a first DI water and a second DI water can be dried; and
a sensing unit that is connected to the first drain line and the second drain line to sense at least one of liquid particle check (LPC) and resistivity of the first DI water or the second DI water passing through the first filter mounting unit and the second filter mounting unit, and
the DI water supply unit is connected to the first supply line or the second supply line to supply the DI water to the first filter mounting unit and the second filter mounting unit and can selectively supply the first DI water having a first temperature and the second DI water having a second temperature lower than the first temperature at desired time intervals.
